(19) United States
(12) Patent Application Publication
(10) Pub. No.: US 2018/0065238 A1
(43) Pub. Date: Mar. 8, 2018

(54) UPPER BEARING HOUSING PULLER APPARATUS

(71) Applicant: Leon Griffin, North Charleston, SC (US)

(72) Inventor: Leon Griffin, North Charleston, SC (US)

(21) Appl. No.: 15/257,040

(22) Filed: Sep. 6, 2016

(51) Int. Cl. B25B 27/06

(52) U.S. Cl. CPC B25B 27/06

(57) ABSTRACT

An apparatus for removing an upper bearing housing from an outboard motor. According to an embodiment, an upper bearing housing apparatus is generally comprised of a hollow body, a slide hammer, a claw collar, two or more claws, and a hammer stop. The apparatus is utilized to remove an upper bearing housing by threading the drive shaft through the hollow body of the apparatus and positioning the claws on opposite sides of the upper bearing housing. A tooth portion at the end of each claw is used to grip an underside of the upper bearing housing. The user applies force to remove the upper bearing housing by sliding the hammer portion upward and striking it against the hammer stop. This generates force on the claw teeth to the pull the upper bearing housing free from the gear case, without damaging the gear case housing and the bearing housing.

### FIELD

The present disclosure relates to the field of marine mechanic tools; in particular, an apparatus for removing an upper bearing housing or a drift shaft collar from an outboard motor.

### BACKGROUND

Outboard motors are extremely popular with many boaters. Outboard motors are generally comprised of an engine, and exhaust housing, and a gearbox. As with all internal combustion motors, regular maintenance and repair is required due to normal wear and tear and worn out parts. Marine outboard motors are comprised of many parts, and mechanics who service these motors utilize numerous tools to service and replace these parts. One such part is an upper bearing housing, which is located in the gearbox and receives the drive or motor shaft, and is often located adjacent to the underside of the water pump wear plate. Occasionally, the upper bearing housing needs to be removed from the gear case for service and/or replacement. Because of the location of the drive shaft and the fact that the bearing housing is often recessed in the gear case, removal of the upper bearing housing can be difficult. The upper bearing housing is commonly removed by using a flat head screwdriver to pry the upper bearing housing out of the gear case. This method of removal, however, is time consuming and risks damage to the gear case housing and the bearing housing.

Through applied effort, ingenuity, and innovation, Applicant has identified a number of deficiencies and problems with prior art solutions for removing an upper bearing housing or a drift shaft collar in boat outboard motors. Applicant has developed a solution that is embodied by the present invention, which is described in detail below.

### SUMMARY

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

Specific embodiments of the present disclosure provide for an apparatus for removing an upper bearing housing from an outboard motor. According to an embodiment, the apparatus comprises a cylindrical body having a first end, a second end, and interior side walls defining a hollow portion extending from the first end to the second end; a slide hammer slideably coupled to the cylindrical body; at least two claws coupled to the first end of the cylindrical body, the at least two claws having a tooth portion at a distal end; a hammer stop coupled to the second end of the cylindrical body.

Embodiments may further include a collar coupled to the first end of the cylindrical body, the collar having a hollow central portion; and a threaded portion disposed upon the first end and the second end of the cylindrical body.

Further specific embodiments of the present disclosure include an apparatus for removing an upper bearing housing from an outboard motor. This embodiment comprises a hollow body being cylindrical in shape, the hollow body having a threaded portion disposed on a first end and a second end; a hammer slideably coupled to the hollow body, the hammer having a flange on a first end and a second ending defining a grip and a strike surface; a means for gripping an upper bearing housing, the means for gripping an upper bearing housing coupled to the treaded portion of the first end of the hollow body; and, a hammer stop coupled to the treaded portion of the second end of the hollow body.

Still further specific embodiments of the present disclosure include an apparatus for removing an upper bearing housing from an outboard motor. The apparatus comprises a hollow body being cylindrical in shape, the hollow body having a threaded portion disposed on a first end and a second end; a means for applying force to the second end of the hollow body; a means for gripping an upper bearing housing, the means for gripping an upper bearing housing coupled to the treaded portion of the first end of the hollow body; and, a hammer stop coupled to the treaded portion of the second end of the hollow body.

The foregoing has outlined rather broadly the more pertinent and important features of the present invention so that the detailed description of the invention that follows may be better understood and so that the present contribution to the art can be more fully appreciated. Additional features of the invention will be described hereinafter which form the subject of the claims of the invention. It should be appreciated by those skilled in the art that the conception and the disclosed specific methods and structures may be readily utilized as a basis for modifying or designing other structures for carrying out the same purposes of the present invention. It should be realized by those skilled in the art that such equivalent structures do not depart from the spirit and scope of the invention as set forth in the appended claims.

### BRIEF DESCRIPTION OF DRAWINGS

The above and other objects, features and advantages of the present disclosure will be more apparent from the following detailed description taken in conjunction with the accompanying drawings, in which:

FIG. 1 is a perspective view of an upper bearing housing puller apparatus, according to an embodiment of the present disclosure;

FIG. 2 is a top down view an upper bearing housing puller apparatus, according to an embodiment of the present disclosure;

FIG. 3 is a side view an upper bearing housing puller apparatus, according to an embodiment of the present disclosure;

FIG. 4 is a side view an upper bearing housing puller apparatus, according to an embodiment of the present disclosure;

FIG. 5 is a perspective view of an upper bearing housing puller apparatus engaged with an upper bearing housing of an outboard motor gearbox, according to an embodiment of the present disclosure.

### DETAILED DESCRIPTION

Exemplary embodiments are described herein to provide a detailed description of the present disclosure. Variations of these embodiments will be apparent to those of skill in the art. Moreover, certain terminology is used in the following description for convenience only and is not limiting. For example, the words “right,” “left,” “top,” “bottom,” “upper,” “lower,” “inner” and “outer” designate directions in the drawings to which reference is made. The word “a” is defined to mean “at least one.” The terminology includes the words above specifically mentioned, derivatives thereof, and words of similar import.

Outboard motors are extremely popular with many boaters. Outboard engines are generally comprised of an engine, and exhaust housing, and a gearbox. As with all internal combustion motors, regular maintenance and repair is required due to wear and tear and worn out parts. Marine outboard motors are comprised of many parts, and mechanics who service these motors utilize numerous tools to service and replace these parts. One such part is an upper bearing housing, which is located in the gearbox and receives the drive or motor shaft, often on the underside of the water pump wear plate. Occasionally, the upper bearing housing needs to be removed from the gear case for service and/or replacement. Because of the location of the drive shaft and the fact that the bearing housing is often recessed in the gear case, removal of the upper bearing housing can be difficult. The upper bearing housing is commonly removed by using a flat head screwdriver to pry the upper bearing housing out of the gear case. This method of removal, however, is time consuming and risks damage to the gear case housing and the bearing housing.

Embodiments of the present disclosure provide for an improved and novel apparatus for removing an upper bearing housing from an outboard motor gear case. According to embodiments of the present disclosure, an upper bearing housing apparatus is generally comprised of a hollow body, a slide hammer, a claw collar, two or more claws, and a hammer stop. After the gearbox is decoupled from the exhaust housing, the apparatus is utilized to remove an upper bearing housing by threading the drive shaft of the outboard motor through the hollow body of the apparatus such that the apparatus can slide down the drive shaft until making contact with the gear case. Once the apparatus is placed over the drive shaft, the claws are positioned on opposite sides of the upper bearing housing. A tooth portion at the end of each claw is used to grip an underside of the upper bearing housing. The user then applies force to remove the upper bearing housing by sliding the hammer portion upward and striking it against the hammer stop. By striking the hammer against the hammer stop, the user generates upward force on the claw teeth to the pull the upper bearing housing free from the gear case, without damaging the water pump wear plate.

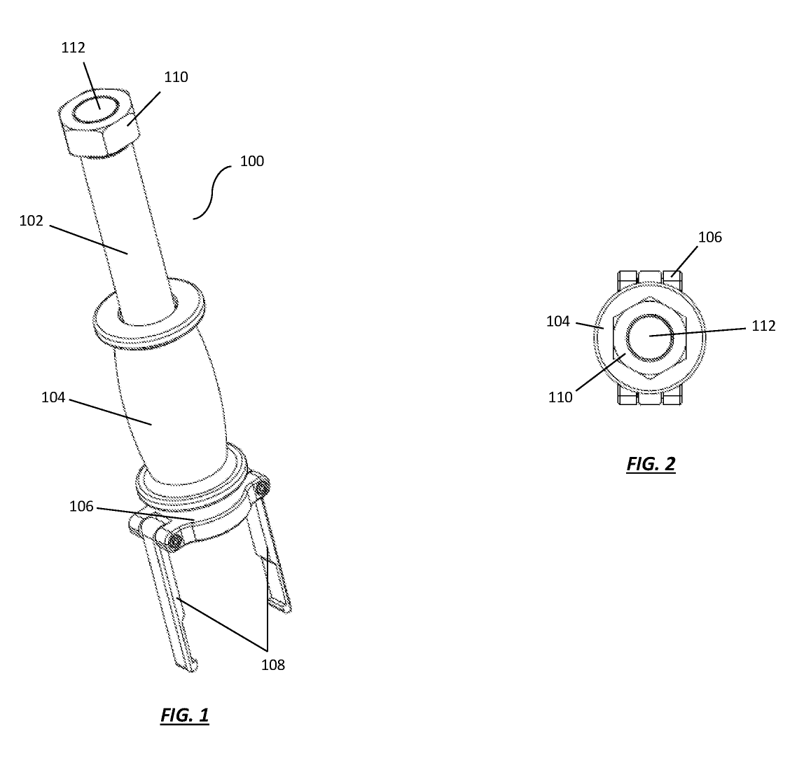

Referring now to FIG. 1, a perspective view of an upper bearing housing puller 100 is shown. According to an embodiment of the present disclosure, upper bearing housing puller 100 is generally comprised of body 102, slide hammer 104, claw collar 106, claws 108, and hammer stop 110. Body 102 is cylindrical in shape and has a hollow channel 112 running the length of body 102. The diameter of channel 112 should be large enough in size to allow the drive shaft of an outboard engine to pass there through, and may be in the range of about half an inch to about three inches. Body 102 may be made of steel, aluminum, or another metal of similar strength. Slide hammer 104 is substantially cylindrical in shape and may be tapering in circumference from a central portion toward its ends to make slide hammer 104 more ergonomic to allow a user to grip it more comfortably. Slide hammer 104 may have a flange on each end defining a striking surface. Slide hammer 104 is hollow through its center such that body 102 may be threaded there through, and slide hammer 104 may slide freely on body 102. Claw collar 106 may be coupled to an end of body 102. Claw collar 106 may have an upper surface configured to prevent slide hammer 104 from sliding off body 102. Slide hammer stop 110 is coupled to an upper portion of body 102, and is configured to stop slide hammer 104 from sliding off body 102 when pulled upward by a user. Hammer stop 110 may be a threaded nut that screws onto a threaded portion 114a of body 102 (as shown in FIG. 3).

Still referring to FIG. 1, claw collar 106 may have a channel on opposite sides in which a claw 108 may be pivotably coupled to claw collar 106 using a pin, set screw or the like. Claw 108 is elongated with a milling toward an end portion to define a tooth. The tooth is configured to grip a bottom portion of an upper barring housing. Claws 108 may pivot to allow them to be positioned to be inserted and removed around an upper barring housing. Claw collar 106 may have a threaded portion configured to screw onto threaded portion 114b of body 102 (as shown in FIG. 3).

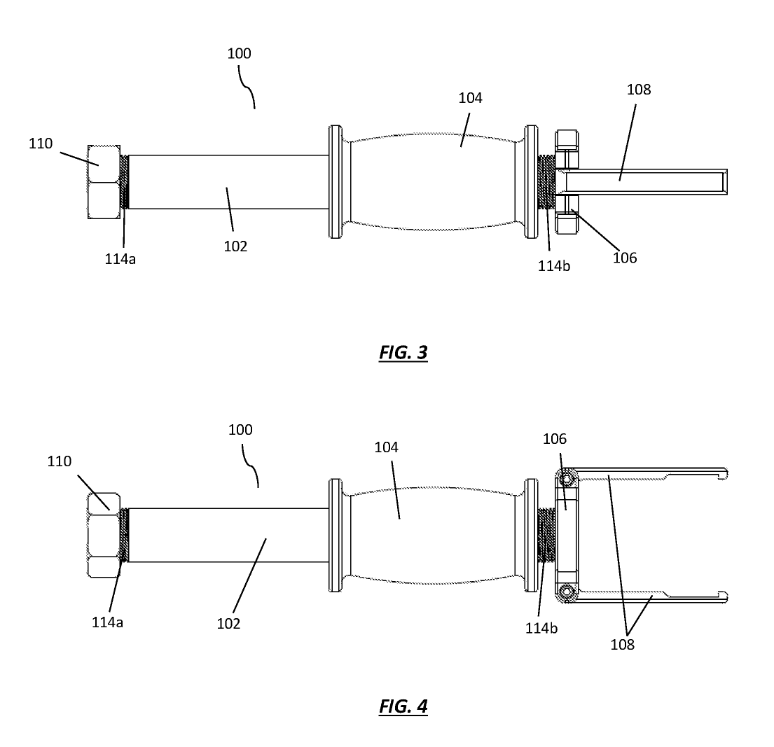

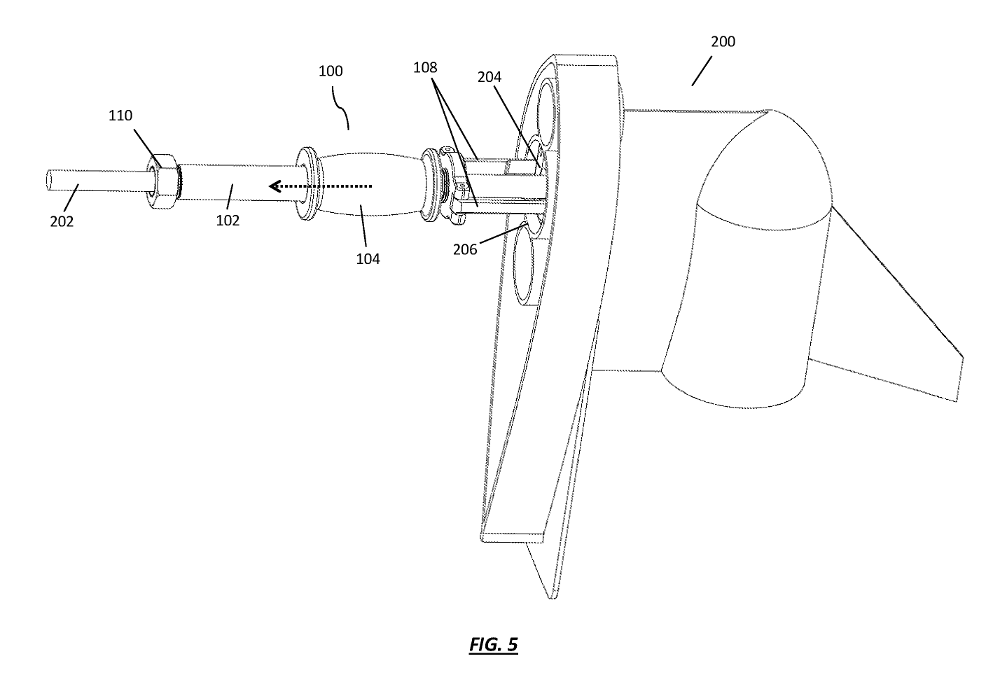

According to the embodiment of FIG. 1, FIG. 2 illustrates a top down view upper bearing housing puller 100, and FIGS. 3 and 4 illustrate side views of upper bearing housing puller 100. FIG. 5 is a perspective view of an upper bearing housing puller 100 engaged with an upper bearing housing 204 of an outboard motor gearbox 200. According to an embodiment, upper bearing housing puller 100 is threaded over drive shaft 202, and claws 108 are secured around upper bearing housing 204, which is recessed in gear case 206. To remove upper bearing housing 204, the user slides hammer 104 away from upper bearing housing 204 and strikes hammer 104 against hammer stop 110. The user repeated strikes slide hammer 104 against hammer stop 110 until upper bearing housing 204 is free from gear case 206. To remove upper bearing housing puller 100, the user slides upper bearing housing puller 100 off drive shaft 202.

Upper bearing housing puller 100 may be manufactured of steel, aluminum, or similar metal. Alternative embodiments are anticipated where claw collar 106 and hammer stop 110 are fixedly coupled to body 102. Body 102 may be any shape other than cylindrical, so long as channel 112 is of sufficient diameter to be threaded over drive shaft 102. Upper bearing housing puller 100 may have more than two claws 108; for example, an alternative embodiment might include four claws. Upper bearing housing puller 100 may also be configured to remove the drive shaft collar from certain outboard engines.

The present disclosure includes that contained in the appended claims as well as that of the foregoing description. Although this invention has been described in its exemplary forms with a certain degree of particularity, it is understood that the present disclosure of has been made only by way of example and numerous changes in the details of construction and combination and arrangement of parts may be employed without departing from the spirit and scope of the invention.

What is claimed is:

1. An apparatus for removing an upper bearing housing from an outboard motor, the apparatus comprising:
a cylindrical body having a first end, a second end, and interior side walls defining a hollow portion extending from the first end to the second end;
a slide hammer slideably coupled to the cylindrical body;
at least two claws coupled to the first end of the cylindrical body, the at least two claws having a tooth portion at a distal end; and,
a hammer stop coupled to the second end of the cylindrical body.

2. The apparatus of claim 1 further comprising a collar coupled to the first end of the cylindrical body, the collar having a hollow central portion.

3. The apparatus of claim 1 further comprising a coupling means disposed upon the first end and the second end of the cylindrical body.

4. The apparatus of claim 1 wherein the hammer further comprises a flange on a first end and a second ending defining a grip.

5. The apparatus of claim 2 wherein the at least two claws are pivotably coupled to the collar.

6. The apparatus of claim 3 further comprising a collar having a central portion defining an aperture, the collar being coupled to the first end of the cylindrical body.

7. The apparatus of claim 4 wherein the flange further comprises a strike surface configured to apply strike force to the hammer stop.

8. The apparatus of claim 6 wherein the at least two claws are pivotably coupled to the collar.

9. The apparatus of claim 7 wherein the hammer stop has a central portion defining an aperture, the hammer stop being coupled to the second end of the cylindrical body.

10. An apparatus for removing an upper bearing housing from an outboard motor, the apparatus comprising:
a hollow body being cylindrical in shape, the hollow body having a threaded portion disposed on a first end and a second end;
a hammer slideably coupled to the hollow body, the hammer having a flange on a first end and a second ending defining a grip and a strike surface;
a means for gripping an upper bearing housing, the means for gripping an upper bearing housing coupled to the treaded portion of the first end of the hollow body; and,
a hammer stop coupled to the treaded portion of the second end of the hollow body.

11. An apparatus for removing an upper bearing housing from an outboard motor, the apparatus comprising:
a hollow body being cylindrical in shape, the hollow body having a threaded portion disposed on a first end and a second end;
a means for applying force to the second end of the hollow body;
a means for gripping an upper bearing housing, the means for gripping an upper bearing housing coupled to the treaded portion of the first end of the hollow body; and,
a hammer stop coupled to the treaded portion of the second end of the hollow body.
